(19) United States
(12) Patent Application Publication
(10) Pub. No.: US 2013/0159667 A1
(43) Pub. Date: Jun. 20, 2013

(54) Vector Size Agnostic Single Instruction Multiple Data (SIMD) Processor Architecture

(71) Applicant: Ilie Garbacea, Santa Clara, CA (US)

(72) Inventor: Ilie Garbacea, Santa Clara, CA (US)

(73) Assignee: MIPS TECHNOLOGIES, INC., Sunnyvale, CA (US)

(21) Appl. No.: 13/328,792

(22) Filed: Dec. 16, 2011

(51) Int. Cl. G06F 9/30; G06F 9/312; G06F 15/76

(52) U.S. Cl. 712/7; 712/200; 712/E09.023; 712/E09.033

(57) ABSTRACT

A computer has a memory adapted to store a first plurality of instructions encoded with a first vector size and a second plurality of instructions encoded with a second vector size. An execution unit executes the first plurality of instructions and the second plurality of instructions by processing vector units in a uniform manner regardless of vector size.

### FIELD OF THE INVENTION

This invention relates generally to processor architectures. More particularly, this invention relates to a Single Instruction Multiple Data (SIMD) processor architecture that processes vectors in the same manner regardless of the size of the vector.

### BACKGROUND OF THE INVENTION

SIMD is a computation technique that performs the same operation on multiple data elements simultaneously. This technique exploits data level parallelism.

A vector is an ordered set of homogeneous data elements, referred to herein as vector units. The vector units correspond to the “multiple data” associated with a single instruction in a SIMD processor. The number of the vector units in a vector defines the vector's size or length. Typically, vector sizes are expressed in bits, as the sum of vector's data elements bit count.

Most SIMD instruction sets operate on a specific number of vector units. Therefore, if there is a change in processor architecture, say from 128-bit vectors to 256-bit vectors, a whole new instruction set is required. Consequently, all existing software needs to be re-written for the new architecture. There is an ongoing need for improved processing power, which results in an ongoing desire for larger vectors. It would be desirable to accommodate changing vector sizes without having to re-write software for each new vector size.

### SUMMARY OF THE INVENTION

A processor has a special register to store a set of vector sizes up to a maximum size given by the implementation. An execution unit performs an operation on multiple vector units of a vector in the same manner regardless of the vector size.

A computer has a storage unit and a processor adapted to execute a single instruction on multiple vector units when a first value of the vector size is selected from the storage unit. The processor is also adapted to execute the same single instruction on multiple vector units when a second value of the vector size is selected from the storage unit.

A computer has a memory adapted to store a first plurality of instructions encoded for using a first vector size and a second plurality of instructions encoded for using a second vector size. An execution unit with a vector size greater or equal then the first and the second vector sizes executes the first plurality of instructions and the second plurality of instructions.

### BRIEF DESCRIPTION OF THE FIGURE

The invention is more fully appreciated in connection with the following detailed description taken in conjunction with the accompanying drawings, in which:

FIG. 1 illustrates a processor configured in accordance with an embodiment of the invention.

### DETAILED DESCRIPTION OF THE INVENTION

The invention utilizes a single instruction set for all vector sizes. The instruction set specifies a type of vector unit, also referred to herein as a data format. This vector unit is processed the same by the execution unit, regardless of the number units within the vector. The number of units within a vector is derived from the vector size value stored in a special register. This accessible value effectively defines the vector size. However, since the instructions operate on vector units, changing vector sizes does not necessitate new instruction sets or the re-writing of computer code.

Table I illustrates a vector unit schema that may be utilized in accordance with an embodiment of the invention.

TABLE I

| Vector Unit and Size in Bits | Abbreviation |
|---|---|
| Byte, 8-bit | .b |
| Halfword, 16-bit | .h |
| Word, 32-bit | .w |
| Doubleword, 64-bit | .d |
| Quadword, 128-bit | .q |
| Vector | .v |

Table I defines vector units with different sizes or data element lengths. The associated abbreviation, e.g. “.b” for byte units, may be added to an instruction. For example, the instruction “add.b” specifies an add operation for all byte vector units. Any instruction may be augmented with the specified abbreviations. Consequently, instructions are defined in connection with a vector unit.

A vector unit index code may also be defined to select individual elements within a vector. Table II illustrates an index scheme that may be used in accordance with an embodiment of the invention.

TABLE II

| Vector Unit | 128-bit Vector | 256-bit Vector |
|---|---|---|
| Byte | n = 0, 1, . . . 15 | n = 0, 1, . . . 31 |
| Halfword | n = 0, 1, . . . 7 | n = 0, 1, . . . 15 |
| Word | n = 0, 1, 2, 3 | n = 0, 1, . . . 7 |
| Doubleword | n = 0, 1 | n = 0, 1, 2, 3 |
| Quadword | n = 0 | n = 0, 1 |

Consider the following example that operates on word vector units (i.e., 32-bit data elements) in a 128-bit vector architecture. The initial values of vector registers w1, w2, and of general purpose register r2 are shown below in Table III.

TABLE III

| | Word 3 | Word 2 | Word 1 | Word 0 |
|---|---|---|---|---|
| w1 | a | b | c | d |
| W2 | A | B | C | D |
| r2 | | | | E |

In this example, vector w1 has four word vector units. The first vector unit has a value of “d”, the second vector unit has a value of “c”, the third vector unit has a value of “b”, while the fourth vector unit has a value of “a”. Vector w2 has a first vector unit with a value of “D”, a second vector unit with a value of “C”, a third vector unit with a value of “B” and a fourth vector unit with a value of “A”. The register r2 has a 32-bit value of “E”.

Consider now the following instructions:
(1) addv.w $w5, $w1, $w2
(2) move.w $w6, $r2
(3) advi.w $w7, $w1, 17
(4) move.w $w8, $w2[2]

Execution of these instructions produces the following results of Table IV:

TABLE IV

| | Word 3 | Word 2 | Word 1 | Word 0 |
|---|---|---|---|---|
| w5 | a + A | b + B | c + C | d + D |
| w6 | E | E | E | E |
| w7 | a + 17 | b + 17 | c + 17 | d + 17 |
| w8 | B | B | B | B |

The first row instruction (1) specifies the addition (addv.w) of vector w1 and w2 with the results being placed in vector w5. Table IV shows the result of this operation. For example, the upper right corner shows the value “d+D”, where the value “d” is from the first vector unit of w1 and the value “D” is from the first vector unit of w2, as shown in Table III.

The second row instruction (2) specifies the movement of the value in register r2 into vector w6. Table IV shows that the register value of “E” from r2 is placed in each vector unit of w6.

The third row instruction (3) specifies the addition of 17 to the values associated with the vector units of vector w1, with the result placed in vector w7. Table IV shows vector w7 with a first vector unit of “d+17”, a second vector unit of “c+17”, a third vector unit of “b+17” and a fourth vector unit of “a+17”.

The fourth row instruction (4) specifies the selection of index value 2 from vector units of vector w2, with the results placed in vector w8. Table IV shows the value “B” placed in each vector unit of vector w8. The value “B” is shown in Table III and corresponds to the value in the third vector unit of vector w2 (the indexing scheme specifies 0, 1, 2, 3, so the specification of unit 2 corresponds to the third vector unit).

This example demonstrates that the invention operates on vector units. Operations are performed in connection with individual vector units, regardless of the number of units in the vector. The same 4 instructions operate not only on the above 4 word/128-bit vectors, but also on 8 word/256-bit vectors. Consequently, a single set of instructions may be used to process vectors that are of different sizes.

An embodiment of the invention utilizes an instruction format that specifies the vector unit for a result produced by the instruction. For example, the signed dot product instruction
dotp_s.d $w9, $w1, $w2
   specifying a double word result on word operators produces the results of Table V.

TABLE V

| | Doubleword 1 | Doubleword 0 |
|---|---|---|
| W9 | a * A + b * B | c * C + d * D |

Table V shows that vector w9 has two double word vector units (each 64 bits), which are used to store the dot product operation on word vector units associated with vectors w1 and w2 of Table III.

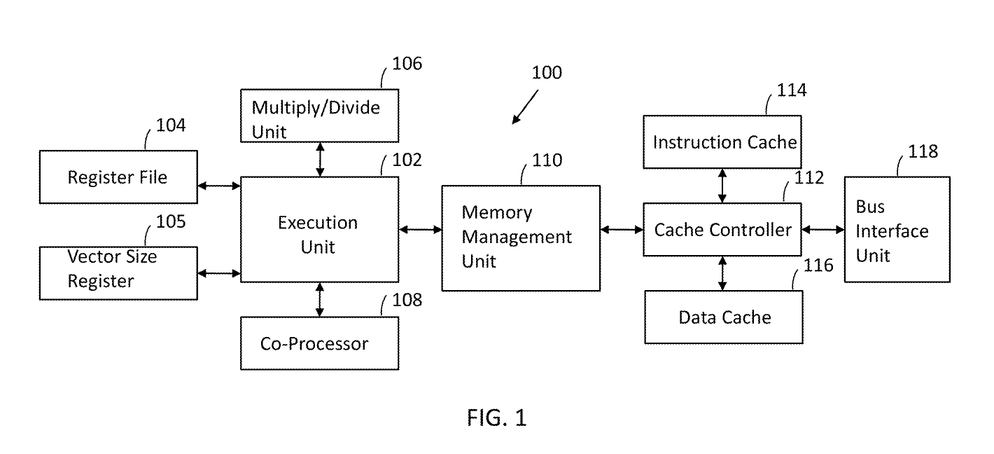

FIG. 1 illustrates a processor 100 configured in accordance with an embodiment of the invention. The processor 100 implements vector size agnostic operations described herein. In particular, the processor implements vector size agnostic operations in connection with single instruction multiple data (SIMD) operations. The architecture supports block processing of each vector unit. That is, each vector unit is treated as a discrete entity that is handled the same way, regardless of the vector size.

The processor 100 includes an execution unit 102 connected to registers 104. At least one register stores the size of the vector. FIG. 1 illustrates a vector size register 105 to store the size of the vector. In on embodiment, the execution unit 102 is connected to a multiply/divide unit 106 and a co-processor 108. The execution unit is also connected to a memory management unit 102, which interfaces with a cache controller 112. The cache controller 112 has access to an instruction cache 114 and a data cache 116. The cache controller 112 is also connected to a bus interface unit 118.

The configuration of processor 100 is exemplary. The vector unit size agnostic processing may be implemented in any number of configurations. The common operations across all such configurations is the the handling of vector units in a uniform manner, regardless of the vector size. The size is fetched from a register, may be loaded at start-up, or may be written by software.

The processing of the invention allows a single set of instructions to be used for vectors of any size. Consequently, vector sizes may be continuously changed without impacting installed software bases.

While various embodiments of the invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on chip (“SOC”), or any other device), implementations may also be embodied in software (e.g., computer readable code, program code, and/or instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known non-transitory computer usable medium such as semiconductor, magnetic disk, or optical disc (e.g., CD-ROM, DVD-ROM, etc.). It is understood that a CPU, processor core, microcontroller, or other suitable electronic hardware element may be employed to enable functionality specified in software.

It is understood that the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A processor, comprising:
a register to store a vector size; and
an execution unit to perform an operation on vector units of a vector in the same manner regardless of the vector size.

2. The processor of claim 1 wherein the vector units are selected from a byte, a halfword, a word, a doubleword, and a quadword.

3. The processor of claim 1 wherein the execution unit evaluates an instruction to determine the vector unit for the result produced by the instruction.

4. The processor of claim 1 wherein the execution unit evaluates a vector element index value associated with an instruction.

5. A computer, comprising:
a storage unit; and
a processor
adapted to execute a single instruction on multiple vector units of a first vector size when a first vector size value is selected from a special register, and
adapted to execute the single instruction on multiple vector units of a second vector size when a second vector size value is selected from the special register.

6. The processor of claim 5 wherein the processor evaluates an instruction to determine the data format for the result produced by the instruction.

7. The processor of claim 5 wherein the processor evaluates a data element index value associated with an instruction.

8. The processor of claim 7 wherein the processor accesses a data element specified by the data element index value.

9. A computer, comprising;
a memory adapted to store a first plurality of instructions encoded with a first vector size and a second plurality of instructions encoded with a second vector size; and
an execution unit with a vector size greater or equal to the first vector size and the second vector size to execute the first plurality of instructions and the second plurality of instructions by processing vector units in a uniform manner regardless of vector size.

10. The computer of claim 9 further comprising a register to store a vector size.

11. The processor of claim 9 wherein the vector units are selected from a byte, a halfword, a word, a doubleword, and a quadword.

12. The processor of claim 9 wherein the execution unit evaluates an instruction to determine the vector unit for the result produced by the instruction.

13. The processor of claim 9 wherein the execution unit evaluates a vector element index value associated with an instruction.

14. A computer readable storage medium, comprising executable instructions to define:
a register adapted to store a set of vector sizes up to a maximum size; and
an execution unit to perform an operation on vector units of a vector in the same manner regardless of the vector size.

15. The computer readable storage medium of claim 14 wherein the vector units are selected from a byte, a halfword, a word, a doubleword, and a quadword.

16. The computer readable storage medium of claim 14 wherein the execution unit evaluates an instruction to determine the vector unit for the result produced by the instruction.

17. The computer readable storage medium of claim 14 wherein the execution unit evaluates a vector element index value associated with an instruction.

18. The computer readable storage medium of claim 17 wherein the execution unit accesses a vector unit specified by the unit index value.
